(19) United States
(12) Patent Application Publication
(10) Pub. No.: US 2008/0129186 A1
(43) Pub. Date: Jun. 5, 2008

(54) IMAGE DISPLAY DEVICE AND SPACER

(76) Inventors: Hiroki Yamamoto, Hitachi (JP); Takashi Naito, Funabashi (JP); Yuichi Sawai, Miyazaki (JP); Osamu Shiono, Hitachi (JP); Motoyuki Miyata, Hitachinaka (JP); Hiroshi Ito, Chiba (JP); Akira Hatori, Chiba (JP); Nobuhiko Hosotani, Miyazaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/933,477

(22) Filed: Nov. 1, 2007

(30) Foreign Application Priority Data
Nov. 1, 2006 (JP) 2006-297767

(51) Int. Cl. H01J 1/62; H01J 19/42

(52) U.S. Cl. 313/495; 313/292

(57) ABSTRACT

To provide a spacer, which is unlikely to degrade due to heating received during manufacture process of an image display device, and an image display device equipped with the spacer. An image display device includes: a cathode substrate including an electron source; an anode substrate including a fluorescent substance that emits light upon receiving electrons emitted from the electron source; and a spacer that is disposed between the cathode substrate and the anode substrate and supports the both substrates, wherein the spacer comprises the one having a film composed of a composite metal oxide on a side surface of a glass base material, the composite metal oxide being composed of a solid solution of a metal oxide having a semiconductor-like electrical conductivity and a metal oxide having an insulator-like electrical conductivity. The spacer equipped with this composite metal oxide film has less degradation, such as that a glass composition volatilizes, even if heated during the manufacture process of an image display device, and provides an excellent image.

### FIELD OF THE INVENTION

The present invention relates to an image display device and a spacer used therefor.

### BACKGROUND OF THE INVENTION

In recent years, as an information processing device or television broadcasting moves into high-definition, a flat panel display device (FPD: Flat Panel Display) are gaining increased attention because it has high brightness and high definition properties and it also achieves light weight and space saving. The typical flat panel display devices include a liquid crystal display device and a plasma display device, and also a field emission display (hereinafter, referred to as FED) that has received attention in recent years.

FED is a self-luminous display device having an electron source in which electron emission elements comprised of a cold cathode element are disposed in a matrix. As the electron emission element, a surface conduction type emission element (SED type), a field emission type element (FE type), a metal/insulating film/metal type emission element (MIM type), and the like are known. Moreover, a spinto type composed of a metal such as molybdenum or a semiconductor material such as silicon, a CNT type using a carbon nanotube as an electron source, and the like are known as the FE type.

In FED, a space needs to be provided between a cathode panel on the back side in which electron sources are formed, and an anode panel on the front side in which fluorescent substances that emit light by being excited by electrons emitted from the electron source, and this space needs to be kept under vacuum atmosphere. In order for the space part kept under vacuum to be able to withstand atmospheric pressure, a supporting member called a spacer is usually disposed between the two panels.

In FED, usually, a voltage is applied to the anode so that the potential difference between the electron source and the anode may be on the order of several kV to several tens of kV. The higher this voltage, the higher brightness and longer life of the panel can be achieved, however, on the other hand the spacer is likely to be charged. If the spacer is charged, such a phenomenon will occur that an electron beam flying from the cathode to the anode is attracted to the spacer side or is repelled to move away from the spacer. This leads to a problem that the brightness varies and a shadow of the spacer is displayed on a screen, thus degrading the image quality. Moreover, electric discharge is likely to occur and thus the cathode and other structural parts can be destroyed. Moreover, there is also a method using an electron conductive glass material having resistivity on the order of 10⁷Ω·cm as the spacer material. As the electron conductive glass, a V—W—P—O-based glass is used. When this glass is used, the so-called emission degradation is observed, that is, constitutive elements of the glass, such as V, W, and P, are scattered into the panel due to a heating process and the like during panel manufacture and then are stuck to an electron source in the vicinity of a spacer, thus degrading the cathode property.

In order to prevent charging of the spacer and the emission degradation, there have been proposed the one wherein a semiconductive film is formed on the surface of a glass base material (for example, see Patent Document 1), or the one wherein a high resistance film is formed on the surface of the glass base material (for example, see Patent Document 2), and the like. As the materials of the semiconductive film, Patent Document 1 describes tin oxide, group four semiconductors, such as silicon and germanium, compound semiconductors of gallium, arsenic, or the like, semiconductor oxides, such as nickel oxide and zinc oxide. Moreover, as the materials of the high resistance film, Patent Document 2 describes NiO film, Fe₂O₃ film, ZnO film, Cr₂O₃ film, and the like.

(Patent Document 1) JP-A-7-282743

(Patent Document 2) JP Patent No. 3302298

### BRIEF SUMMARY OF THE INVENTION

As described above, forming an antistatic film on the surface of the glass base material is effective in suppressing the problem that a shadow of the spacer is displayed on a screen, and the like. However, it has been found that the thin film materials conventionally studied are likely to degrade due to heating received during manufacture process of the image display device. The degradation of this thin film causes a problem that the emission degradation and the like cannot be suppressed.

It is an object of the present invention to provide a spacer, which is unlikely to degrade due to heating applied during manufacture process of the image display device, and an image display device equipped with the spacer.

According to an aspect of the present invention, an image display device includes: a cathode substrate including an electron source; an anode substrate including a fluorescent substance that emits light upon receiving electrons emitted from the electron source; a spacer that is disposed between the cathode substrate and the anode substrate and supports the both substrates, wherein the spacer comprises the one having a film composed of a composite metal oxide on a side face of a glass base material, wherein the composite metal oxide is composed of a solid solution of a metal oxide having a semiconductor-like electrical conductivity and a metal oxide having an insulator-like electrical conductivity.

According to another aspect of the invention, a spacer used for an image display device has a film formed of a composite metal oxide on a side surface of a glass base material, the composite metal oxide being composed of a solid solution of a metal oxide having a semiconductor-like electrical conductivity and a metal oxide having an insulator-like electrical conductivity.

Other objects, features and advantages of the invention will become apparent from the following description of the embodiments of the invention taken in conjunction with the accompanying drawings.

### BRIEF DESCRIPTION OF THE DRAWINGS

FIG. 1 is a cross sectional view showing a configuration of a spacer according to the present invention.

FIG. 2 is a perspective view showing an external appearance of an MIN type FED.

FIG. 3 is a cross sectional view showing a part in the direction of A-A line in FIG. 2.

FIG. 4 is a view showing spectra before and after heating in the case where an Fe₂O₃ film is formed on a glass substrate and is heated.

FIG. 5 is a view showing spectral transmittance curves before and after heating in the case where a composite metal oxide film composed of Fe₂O₃ and Ga₂O₃ is formed on a glass substrate.

### DESCRIPTION OF REFERENCE NUMERALS

110 . . . spacer, 111 . . . glass base material, 112 . . . composite metal oxide film, 113 . . . metal film, 114 . . . adhering frit, 115 . . . adhering frit, 210 . . . front panel, 211 . . . anode substrate, 212 . . . black matrix, 213 . . . fluorescent substance, 220 . . . back panel, 221 . . . cathode substrate, 222 . . . electrode, 223 . . . electron source, 230 . . . sealing frame.

### DETAILED DESCRIPTION OF THE INVENTION

Hereinafter, a case where a spacer of the present invention is applied to an MIM type FED will be described, however, the present invention is not limited to the MIM type.

### EXAMPLE 1

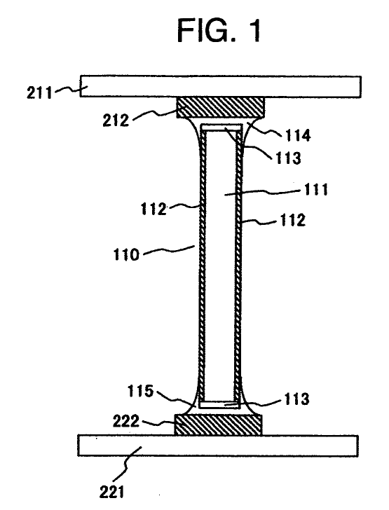

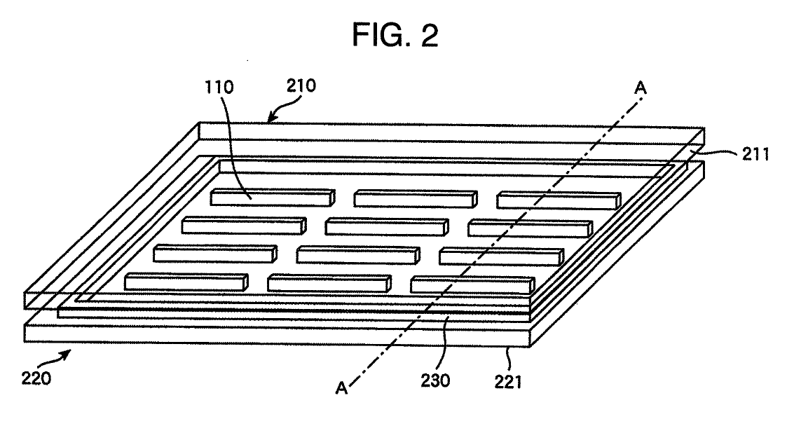

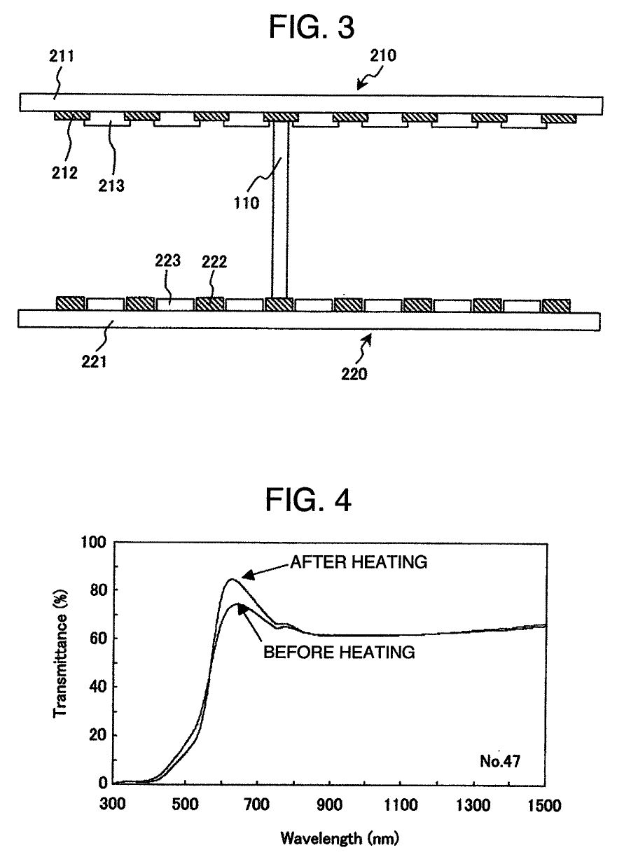

FIG. 1 shows a schematic view of a cross section of a spacer concerning this example. FIG. 2 shows a perspective view of the MIM type FED, and FIG. 3 shows a part of the cross section in the direction of A-A line in FIG. 2.

A front panel 210 includes a black matrix 212, which is a light shielding film, and a fluorescent substance layer 213 on an inner surface side of an anode substrate 211 that is a base material of a panel. Moreover, a back panel 220 includes an electrode 222 and an electron source 223, which is an emitter, on an inner surface side of a cathode substrate 221 that is a base material of the panel.

A number of spacers 110 are disposed between the black matrix 212 formed in the front panel 210 and the electrode 222 formed in the back panel 220. These spacers are adhered to the front panel via an adhering frit 114 and are adhered to the back panel via an adhering frit 115. For the adhering frit, an electrically conductive one is typically used because a very small electric current flows through the spacer.

A sealing frame 230 is provided at the inner peripheral edges of the anode substrate 211 and cathode substrate 221, and this sealing frame is adhered to the anode substrate and to the cathode substrate with an adhesive, and thus a space portion is formed between the back panel and the front panel, and this space portion serves as a display region. The distance between the front panel and the back panel is typically about 3 to 5 mm, and the space portion is usually kept under vacuum atmosphere at a pressure of 10⁻⁵ to 10⁻⁷ Torr.

In the FED thus configured, if an acceleration voltage on the order of several kV to several tens of kV is applied between the back panel 220 and the front panel 210, electrons are emitted from an electron source, which is the emitter, and are collided with the fluorescent substance 213 by the acceleration voltage, and then the electrons excite the fluorescent substance 213 to thereby emit light of a predetermined frequency to the outside of the front panel 210. An image is thus displayed.

The spacer 110 has a composite metal oxide film 112 on the side surface of a glass base material 111 as shown in FIG. 1. In this example, a metal film 113 is formed on the end face of the spacer in consideration of conduction to the adhering frit.

Hereinafter, problems when the spacer degraded due to heating received during the FED manufacture process, and their countermeasures will be described in the light of experimental results.

Here, V—W—Mo—P—Ba—O-based electronic conducting glass was used as the glass base material of the spacer. The conductive glass was used because a current will flow into the base material and the withstand voltage can be increased and thus a bright image quality can be obtained.

Due to heat applied during the panel manufacture process, some of glass compositions, such as V, W, and Mo, volatilize from the glass base material of the spacer and deposit on the cathode. This changes the luminous efficiency of an emitter in the vicinity of the spacer and the so-called emission degradation will occur. In order to suppress volatilization of the glass composition, it is effective to form a volatilization suppression film on the surface of the base material. On the other hand, this film is also required to have an antistatic function of the spacer, and therefore selection of the film material is extremely important.

The film formed on the surface of the glass substrate is irradiated with electrons emitted from the electron source, which is the emitter, and the reflection electrons and secondary electrons from the anode and other constituting members. For this reason, the film is required to have a low resistance so as to suppress charging due to the electrons emitted and so as not to bend the trajectory of an electron beam. However, if the resistance is too low, the consumption of current that flows due to a voltage applied between the anode substrate and the cathode substrate will increase and the risk of thermal runaway is also likely to occur. It is therefore necessary to adjust the resistance to an appropriate one, preferably in the range of 1×10¹⁰ to 1×10¹³. The thermal runaway is a phenomenon in which the spacer is heated to be in a high temperature state due to the spacer current flowing between the anode substrate and the cathode substrate and thereby the resistance of the spacer itself decreases and a further larger current will flow to increase the temperature, and consequently by repeating the phenomenon of further reducing the resistance, the spacer itself becomes hooter than its own softening temperature and will blow off.

Moreover, with regard to the film, the property is required not to vary with the heat at temperatures on the order of 460° C. applied during panel manufacture process.

After studying the film materials in consideration of the various properties described above, it has been found that a complex oxide composed of a solid solution of a metal oxide having a semiconductor-like electrical conductivity, such as Fe₂O₃, and a metal oxide having an insulator-like electrical conductivity, such as Ga₂O₃, is extremely preferable.

With regard to various kinds of film materials, Table 1 shows the composition (mol %), film thickness, surface resistance before heating, surface resistance after heat treatment at 460° C. for two hours, presence or absence of unevenness in film in the external appearance after this heating process, voltage at which thermal runaway occurs, presence or absence of emission degradation, beam deflection amount, and power consumption in a preproduction 17 inch panel.

TABLE 1

| | | | | | Surface | | | | | |
|---|---|---|---|---|---|---|---|---|---|---|
| | | | | | resistance | | Voltage at | | | |
| | | | | | (Ω/square) | Is uneven- | which | | | |
| | | | Film | Surface | after heat | ness in | thermal | | | |
| | | Film | thick- | resistance | treatment at | film after | runaway | Emission | Deflection | Power |
| | | composition | ness | (Ω/square) | 460° C. for | heating | occurs | degradation | amount | consumption |
| | No. | (mol %) | (nm) | (as-deposited) | two hours | present? | (kV) | (%) | (μm) | (W) |
| Example | 1 | 80Fe₂O₃—20Ga₂O₃ | 50 | 5.4 × 10¹¹ | 5.3 × 10¹¹ | No | Not observed | Not observed | 20 | 13 |
| | 2 | 70Fe₂O₃—30Ga₂O₃ | 50 | 8.0 × 10¹¹ | 7.8 × 10¹¹ | No | Not observed | Not observed | 15 | 13 |
| | 3 | 50Fe₂O₃—50Ga₂O₃ | 50 | 1.3 × 10¹² | 1.5 × 10¹² | No | Not observed | Not observed | 17 | 11 |
| | 4 | 30Fe₂O₃—70Ga₂O₃ | 50 | 1.9 × 10¹² | 1.9 × 10¹² | No | Not observed | Not observed | 18 | 12 |
| | 5 | 20Fe₂O₃—80Ga₂O₃ | 50 | 2.1 × 10¹² | 2.3 × 10¹² | No | Not observed | Not observed | 19 | 10 |
| | 6 | 80Cr₂O₃—20Ga₂O₃ | 50 | 5.5 × 10¹⁰ | 5.3 × 10¹⁰ | No | Not observed | Not observed | 15 | 16 |
| | 7 | 50Cr₂O₃—50Ga₂O₃ | 50 | 1.3 × 10¹¹ | 1.2 × 10¹¹ | No | Not observed | Not observed | 12 | 13 |
| | 8 | 20Cr₂O₃—80Ga₂O₃ | 50 | 9.5 × 10¹¹ | 9.2 × 10¹¹ | No | Not observed | Not observed | 16 | 12 |
| | 9 | 80Fe₂O₃—20Al₂O₃ | 50 | 6.5 × 10¹¹ | 6.7 × 10¹¹ | No | Not observed | Not observed | 17 | 13 |
| | 10 | 70Fe₂O₃—30Al₂O₃ | 50 | 9.2 × 10¹¹ | 9.6 × 10¹¹ | No | Not observed | Not observed | 19 | 12 |
| | 11 | 50Fe₂O₃—50Al₂O₃ | 50 | 2.2 × 10¹² | 2.4 × 10¹² | No | Not observed | Not observed | 20 | 10 |
| | 12 | 30Fe₂O₃—70Al₂O₃ | 50 | 1.3 × 10¹² | 1.2 × 10¹² | No | Not observed | Not observed | 16 | 11 |
| | 13 | 20Fe₂O₃—80Al₂O₃ | 50 | 3.1 × 10¹² | 3.3 × 10¹² | No | Not observed | Not observed | 15 | 9 |
| | 14 | 80Mn₂O₃—20Ga₂O₃ | 50 | 7.2 × 10¹⁰ | 7.4 × 10¹⁰ | No | Not observed | Not observed | 13 | 16 |
| | 15 | 50Mn₂O₃—50Ga₂O₃ | 50 | 2.1 × 10¹¹ | 2.0 × 10¹¹ | No | Not observed | Not observed | 12 | 14 |
| | 16 | 20Mn₂O₃—80Ga₂O₃ | 50 | 9.0 × 10¹¹ | 8.8 × 10¹¹ | No | Not observed | Not observed | 18 | 12 |
| | 17 | 80Ni₂O₃—20Ga₂O₃ | 50 | 5.4 × 10¹⁰ | 5.5 × 10¹⁰ | No | Not observed | Not observed | 14 | 17 |
| | 18 | 50Ni₂O₃—50Ga₂O₃ | 50 | 3.4 × 10¹¹ | 3.2 × 10¹¹ | No | Not observed | Not observed | 16 | 15 |
| | 19 | 20Ni₂O₃—80Ga₂O₃ | 50 | 8.6 × 10¹¹ | 8.5 × 10¹¹ | No | Not observed | Not observed | 15 | 14 |
| | 20 | 80V₂O₃—20Ga₂O₃ | 50 | 3.6 × 10¹⁰ | 3.4 × 10¹¹ | No | Not observed | Not observed | 14 | 16 |
| | 21 | 50V₂O₃—20Ga₂O₃ | 50 | 2.8 × 10¹¹ | 2.9 × 10¹¹ | No | Not observed | Not observed | 14 | 13 |
| | 22 | 20V₂O₃—80Ga₂O₃ | 50 | 8.8 × 10¹¹ | 8.9 × 10¹¹ | No | Not observed | Not observed | 15 | 12 |
| | 23 | 80Rh₂O₃—20Ga₂O₃ | 50 | 2.8 × 10¹⁰ | 2.6 × 10¹⁰ | No | Not observed | Not observed | 17 | 17 |
| | 24 | 50Rh₂O₃—50Ga₂O₃ | 50 | 5.1 × 10¹¹ | 5.0 × 10¹¹ | No | Not observed | Not observed | 15 | 13 |
| | 25 | 20Rh₂O₃—80Ga₂O₃ | 50 | 9.8 × 10¹¹ | 9.9 × 10¹¹ | No | Not observed | Not observed | 16 | 12 |
| | 26 | 80Mo₂O₃—20Ga₂O₃ | 50 | 1.6 × 10¹⁰ | 1.5 × 10¹⁰ | No | Not observed | Not observed | 17 | 18 |
| | 27 | 50Mo₂O₃—50Ga₂O₃ | 50 | 4.3 × 10¹¹ | 4.5 × 10¹¹ | No | Not observed | Not observed | 18 | 13 |
| | 28 | 20Mo₂O₃—80Ga₂O₃ | 50 | 8.6 × 10¹¹ | 8.6 × 10¹¹ | No | Not observed | Not observed | 19 | 12 |
| | 29 | 80Ru₂O₃—20Ga₂O₃ | 50 | 1.2 × 10¹⁰ | 1.4 × 10¹⁰ | No | Not observed | Not observed | 20 | 18 |
| | 30 | 50Ru₂O₃—50Ga₂O₃ | 50 | 3.9 × 10¹¹ | 3.7 × 10¹¹ | No | Not observed | Not observed | 18 | 14 |
| | 31 | 20Ru₂O₃—80Ga₂O₃ | 50 | 2.5 × 10¹¹ | 2.3 × 10¹¹ | No | Not observed | Not observed | 17 | 15 |
| | 32 | 70Fe₂O₃—30Ga₂O₃ | 10 | 4.0 × 10¹² | 4.2 × 10¹² | No | Not observed | Not observed | 18 | 12 |
| | 33 | 70Fe₂O₃—30Ga₂O₃ | 20 | 2.0 × 10¹² | 2.3 × 10¹² | No | Not observed | Not observed | 19 | 11 |
| | 34 | 70Fe₂O₃—30Ga₂O₃ | 30 | 1.3 × 10¹² | 1.1 × 10¹² | No | Not observed | Not observed | 20 | 11 |
| | 35 | 70Fe₂O₃—30Ga₂O₃ | 60 | 6.7 × 10¹¹ | 6.4 × 10¹¹ | No | Not observed | Not observed | 20 | 14 |
| | 36 | 70Fe₂O₃—30Ga₂O₃ | 70 | 5.7 × 10¹¹ | 5.9 × 10¹¹ | No | Not observed | Not observed | 18 | 15 |
| | 37 | 70Fe₂O₃—30Ga₂O₃ | 100 | 4.0 × 10¹¹ | 5.2 × 10¹¹ | No | Not observed | Not observed | 18 | 14 |
| | 38 | 70Fe₂O₃—30Ga₂O₃ | 200 | 2.0 × 10¹¹ | 2.8 × 10¹¹ | No | Not observed | Not observed | 17 | 15 |
| | 39 | 70Fe₂O₃—30Ga₂O₃ | 5 | 8.0 × 10¹² | 3.8 × 10¹² | No | Not observed | Not observed | 18 | 12 |
| | 40 | 70Fe₂O₃—30Ga₂O₃ | 7 | 5.7 × 10¹² | 2.1 × 10² | No | Not observed | Not observed | 19 | 12 |
| | 41 | 70Fe₂O₃—30Ga₂O₃ | 300 | 1.3 × 10¹¹ | 5.6 × 10¹⁰ | Slightly | Not observed | Not observed | 20 | 16 |
| | 42 | 70Fe₂O₃—30Ga₂O₃ | 500 | 8.0 × 10¹⁰ | 3.6 × 10¹⁰ | Slightly | Not observed | Not observed | 18 | 18 |
| | 43 | 90Fe₂O₃—10Ga₂O₃ | 50 | 2.7 × 10¹⁰ | 2.9 × 10¹⁰ | No | Not observed | Not observed | 18 | 20 |
| | 44 | 10Fe₂O₃—90Ga₂O₃ | 50 | 2.4 × 10¹² | 2.2 × 10¹² | No | Not observed | Not observed | 50 | 14 |
| | 45 | 90Cr₂O₃—10Ga₂O₃ | 50 | 7.0 × 10⁹ | 6.8 × 10⁹ | No | Not observed | Not observed | 18 | 21 |
| | 46 | 10Cr₂O₃—90Ga₂O₃ | 50 | 2.3 × 10¹¹ | 2.5 × 10¹¹ | No | Not observed | Not observed | 51 | 20 |
| Compara- | 47 | Fe₂O₃ | 50 | 7.3 × 10⁹ | 4.2 × 10⁹ | No | 7.0 | Not observed | 18 | 21 |
| tive | 48 | Cr₂O₃ | 50 | 5.7 × 10⁹ | 2.6 × 10⁹ | No | 6.0 | Not observed | 19 | 20 |
| Example | 49 | Ga₂O₃ | 50 | 2.7 × 10¹² | 2.8 × 10¹² | No | Not observed | Not observed | 150 | 13 |
| | 50 | Al₂O₃ | 50 | 1.2 × 10¹³ | 2.0 × 10¹³ | No | Not observed | Not observed | 180 | 10 |
| | 51 | Mn₂O₃ | 50 | 6.2 × 10⁹ | 2.6 × 10⁹ | No | 7.0 | Not observed | 20 | 21 |
| | 52 | Ni₂O₃ | 50 | 5.6 × 10⁹ | 3.7 × 10⁹ | No | 6.0 | Not observed | 19 | 20 |
| | 53 | V₂O₃ | 50 | 4.1 × 10⁹ | 1.8 × 10⁹ | No | 5.5 | Not observed | 18 | 22 |
| | 54 | Rh₂O₃ | 50 | 3.6 × 10⁹ | 1.7 × 10⁹ | No | 5.0 | Not observed | 18 | 20 |
| | 55 | Mo₂O₃ | 51 | 2.8 × 10⁹ | 1.2 × 10⁹ | No | 4.5 | Not observed | 19 | 22 |
| | 56 | Ru₂O₃ | 50 | 1.5 × 10⁹ | 0.9 × 10⁹ | No | 4.0 | Not observed | 20 | 25 |
| | 57 | 50Fe₂O₃—50SiO₂ | 50 | 2.2 × 10¹¹ | 2.9 × 10⁹ | Yes | 9.0 | 10 | 40 | 18 |
| | 58 | 50Cr₂O₃—50SiO₂ | 50 | 1.0 × 10¹¹ | 2.8 × 10⁹ | Yes | 9.0 | 20 | 52 | 18 |

Here, the film was deposited by sputtering, however, as the film formation method, a coating and baking method via a solution, such as a spray method, a dip method, a sol-gel method, a dice method, and a spin coat method may be used.

The film formation method by sputtering that was carried out in this example is described taking a composite metal oxide film composed of Fe₂O₃ and Ga₂O₃ as an example. The film formation was carried out using a target with dimensions of 152.4 mm φ×5 mm t, which was produced by mixing Fe₂O₃ and Ga₂O₃ so as to provide a desired film composition and then sintering the same using hot pressing. An Ar gas containing O₂ by 5 volume % was used as the forming gas. As the power supply, an rf magnetron power supply was used and a high voltage on the order of 700 W was applied to the target. The vacuum pressure inside the film formation chamber before film formation was set to 4.0×10⁵ Pa.

In order to analyze the composition after the film formation, the film was formed in a thickness of approximately 200 mm on a polyimide film, and the composition analysis was conducted using ICP spectroscopy. The result of this composition analysis was entered as the film composition. In addition, the composition is represented by mol %.

The film material was formed in a thickness of 50 nm on a V—W—Mo—P—Ba—O-base electronic conducting glass base material under the above-described sputtering condition. The size of the base material was set to 110 mm×3 mm×0.15 mm, and the film formation was carried out to the portion of 110 mm×3 mm. Since the sputtering rate of the film varies depending on the composition, the film formation was carried out calculating the rate for each composition. After completion of the film formation on one side, the sample was taken out into the atmosphere once, and the upper and lower sides are reversed and thereafter the film formation on the rear surface was carried out. In this manner, the film formation under the same condition was carried out to the both sides of the spacer.

Moreover, after completion of the film formation, Cr was formed in a thickness of approximately 100 nm as the metal film on both end faces (110×0.15 mm portion) of the spacer, the both end faces serving as a joint part with the anode substrate and with the cathode substrate.

The surface resistance was measured immediately after the film was formed on the spacer substrate by sputtering (as-deposited), and after the heat treatment at 460° C. for two hours. The distance between the electrodes was set to 30 mm, and a high voltage of 1 kV was applied to between the electrodes to measure the surface resistance. The measurement was carried at room temperature in either case. Moreover, after heating, in order to check whether unevenness in film due to a change of state of the film has occurred, the presence or absence of unevenness in film was observed by visual check and by using an optical microscope.

Next, the prepared spacer was mounted inside an MIM type FED structure to prepare the FED panel shown in FIG. 2 and FIG. 3, and the presence or absence of thermal runaway, emission degradation, and power consumption were studied. If the thermal runaway was observed, a voltage at which this phenomenon occurs was entered in the “voltage at which thermal runaway occurs (kV)” column of Table 1, and if not observed, “not observed” was entered. In this study, the maximum voltage between the anode and the cathode was set to 12 kV, and if thermal runaway was not observed at 12 kV, “not observed” was entered.

Moreover, with regard to the emission degradation, the emission current value from an emitter disposed in the first line just proximal to a gate electrode where a spacer is formed, the emission current value from an emitter formed in around the second to third line from this emitter, and the emission current value from an emitter formed in the 20th line from the spacer were simultaneously detected, and the emission current value from the emitter formed in around the second to third line was measured as a relative value when the emission current value from the emitter formed in the 20th line is defined as 100%, and then if a reduction in the emission current value was observed, the reduction amount was entered as the relative value. Moreover, if the decrease in the emission current was equal to or less than 1%, “not observed” was entered.

If the emission degradation exceeds 5%, then the luminescence of the fluorescent substance only in the vicinity of the spacer will decrease due to this degradation, so that a dark belt will be observed along the spacer, which is not desirable. If the emission degradation is equal to or less than 5%, there is no problem because human eyes can not observe this dark belt.

Moreover, the beam deflection amount in the emitter disposed in the first line just proximal to the gate electrode where the spacer is formed was evaluated. The beam deflection is a phenomenon that is caused as follows, that is, if the electrical resistance of the spacer is high and the secondary electron emission coefficient is greater than 1 or this is smaller than 1, positive charges or negative charges are stored on the surface of the spacer, and the emission current is attracted by the charges stored on this surface if the charges stored on this surface are positive charges, and the emission current is repelled if the charges stored on this surface are negative charges, and a position deviating from the center of the fluorescent substance on the anode substrate formed right above the emitter is irradiated with this electron beam. This phenomenon is not desirable because if the beam deflection occurs, a region where a fluorescent substance does not emit light will occur and thereby a linear black belt will be observed along the spacer. The amount of deviation of the beam deflection was quantitatively evaluated using a magnifying glass and the value of the amount of deviation was entered. If the beam deflection is equal to or less than 20 μm, human eyes can not observe the black belt caused by the deviation, so this is desirable.

In Table 1, the power consumption of the whole 17 inch panel is expressed in W. With regard to the MIM type FED panel used in the experiment, six lines of spacers are formed in the 17 inch panel and three pieces of spacers of 110 mm in length are formed with approximately 15 mm gap provided in each line. Accordingly, the number of spacers mounted per panel is 18. If this power consumption is larger than 20 W, it is not desirable because the power consumed in one panel becomes huge. The power consumption is preferably less than 20 W.

No. 1 to No. 46 are the films according to the present invention. No. 47 to No. 58 are the films according to comparative examples. In this example, as the metal oxide having semiconductor-like properties, Fe₂O₃, Cr₂O₃, Mn₂O₃, Ni₂O₃, V₂O₃, Rh₂O₃, Mo₂O₃, and Ru₂O₃ having a trivalent valence were selected. Moreover, as the metal oxide having insulation-like properties, Al₂O₃ and Ga₂O₃ having a trivalent valence were selected as in the above-described semiconductive oxides. The insulative metal oxide was contained in the semiconductive oxide to form a solid solution. No. 1 to No. 5, and No. 32 to No. 44 are composite metal oxide films composed of Fe₂O₃ and Ga₂O₃. No. 6 to No. 8, No. 45, and No. 46 are composite metal oxide films composed of Cr₂O₃ and Ga₂O₃. No. 9 to No. 13 are composite metal oxide films composed of Fe₂O₃ and Al₂O₃, No. 14 to No. 16 are composite metal oxide films composed of Mn₂O₃ and Ga₂O₃, No. 17 to No. 19 are composite metal oxide films composed of Ni₂O₃ and Ga₂O₃, and No. 20 to No. 22 are composite metal oxide films composed of V₂O₃ and Ga₂O₃. Moreover, No. 23 to No. 25 are composite metal oxide films composed of Rh₂O₃ and Ga₂O₃, No. 26 to No. 28 are composite metal oxide films composed of Mo₂O₃ and Ga₂O₃, and No. 29 to No. 31 are composite metal oxide films composed of Ru₂O₃ and Ga₂O₃.

In either one of the films according to the present invention, emission degradation was not observed and thermal runaway was not observed either. Moreover, it turned out that in the films according to the present invention, there is few variation between the surface resistance values before heating and after heating, and all the surface resistance values, except those of some films, after heating are in the range of 1×10¹⁰ to 1×10¹³ Ω/square.

With regard to the composite metal oxide film of No. 45 composed of 90% Cr₂O₃ and 10% Ga₂O₃ by mole ratio on oxide conversion, a phenomenon was observed that the surface resistance is smaller than 1×10¹⁰ and the power consumption is slightly larger than 20 W. Moreover, with regard to the composite metal oxide film of No. 46 composed of 10% Cr₂O₃ and 90% Ga₂O₃ by mole ratio on oxide conversion and the composite metal oxide film of No. 44 composed of 10% Fe₂O₃ and 90% Ga₂O₃, a phenomenon was observed that the beam deflection amount increases. These results show that the composition of the composite metal oxide is preferably set to 80 to 20% of either one of Fe₂O₃, Cr₂O₃, Mn₂O₃, Ni₂O₃, V₂O₃, Rh₂O₃, Mo₂O₃, or Ru₂O₃, and to 20 to 80% of Ga₂O₃ or Al₂O₃ by mole ratio on oxide conversion. If the content of the metal oxide having semiconductor-like electrical conductivity, such as Fe₂O₃, is less than 20 mol %, the resistance increases and the beam deflection tends to increase. Moreover, if it exceeds 80 mol %, the resistance decreases, the power consumption increases, and thermal runaway tends to more likely to occur due to an application of a high voltage.

In the films of No. 41 and No. 42 whose thickness is thick, a slight unevenness in film after heating was observed. Unevenness in film is one of the causes of image quality degradation. Since unevenness in film is likely to occur even when the thickness of the film is too thick or too thin, the film thickness is preferably set in the range from 10 nm to 200 nm.

Although No. 47 to No. 56 are a single layer film of Fe₂O₃, Cr₂O₃, Mn₂O₃, Ni₂O₃, V₂O₃, Rh₂O₃, Mo₂O₃, or Ru₂O₃, all the surface resistance values of these films are in the 10⁹ Ω/square range. For this reason, thermal runaway occurred at an applied voltage of 4 to 9 kV and additionally the power consumption was also equal to or greater than 20 W, which was not desirable.

No. 57 and No. 58 are the films in which SiO₂ is contained in Fe₂O₃ or Cr₂O₃, however, they were not a solid solution. It was found that in this film the surface resistance value after two hour heat treatment at 460° C. decreased by approximately two digits with respect to the surface resistance value as-deposited immediately after the film formation. Moreover, looking at the external appearance of this film, unevenness in film was observed. Furthermore, in the panel equipped with a spacer having this film formed thereon, the emission degradation was as large as 10 to 20%, leading to an undesirable result.

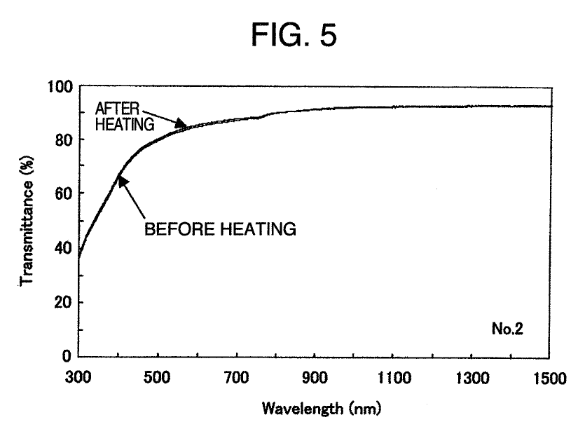

With regard to the spectral transmittance curves before and after heating in the case where the films of NO. 2 and No. 47 are formed on transparent glass substrates and are heated respectively, FIG. 4 shows the curves of No. 47 and FIG. 5 shows the curves of NO. 2. Measurement of the spectral transmittance curve was carried using a spectrophotometer (U4100) manufactured by Hitachi, Ltd. With regard to the one having the Fe₂O₃ film of No. 47 shown in FIG. 4, the spectral transmittance curve after heating varies greatly with respect to the curve before heating. On the other hand, with regard to the one having the composite metal oxide film composed of Fe₂O₃ and Ga₂O₃ of NO. 2 shown in FIG. 5, little variation of the spectral transmittance curves was observed before and after heating.

As described above, in the composite metal oxides that were prepared by adding an insulative metal oxide material, such as Al₂O₃ or Ga₂O₃, into a semiconductive metal oxide material, such as Fe₂O₃ or Cr₂O₃, an excellent spacer with an appropriate resistance value and with no emission degradation due to volatilization of a glass base material component could be obtained.

In order to find out the cause why a difference occurs in the effect between the Fe₂O₃—Ga₂O₃-based film and the Fe₂O₃—SiO₂-based film, nano structures of these films were analyzed using the transmission electron microscope. As a result, comparison of the nano structures before and after heating confirmed that in the case of the Fe₂O₃—Ga₂O₃-based films, in either before or after heating, no heterogeneity of the structure, such as each segregation, was observed and Fe₂O₃ is complexed with Ga₂O₃ and the Ga₂O₃ dissolves into Fe₂O₃ to form a solid solution and form a nano crystal having a grain diameter of approximately 5 to 10 mm.

On the other hand, in the case of Fe₂O₃—SiO₂-based films, it was confirmed that in the as-deposited state before heating, homogeneous nano crystal grains were formed, however, SiO₂ segregates to the Fe₂O₃ grain, as a component of grain boundary phase. Then, it was confirmed that by heating at 460° C., the segregation of SiO₂ becomes more pronounced and thus Fe₂O₃ and SiO₂ exist separately.

The case of Fe₂O₃—Ga₂O₃-based films features that the valence of an Ga ion forming Ga₂O₃ is trivalent as Fe in Fe₂O₃ is and that their ion radiuses are extremely close to each other, and thus the both ions easily dissolve into the respective crystal lattices and easily form a solid solution. On the other hand, while SiO₂ is an excellent insulator material, the Si ion is quadrivalent and the ion radius differs greatly from that of the Fe ion, and therefore a solid solution will not be formed. It is believed that because the film is formed in a thermodynamically unstable state in sputtering, SiO₂ slightly dissolves into the Fe₂O₃ crystal in the as-deposited state, but the SiO₂ is discharged from the inside of the crystal lattice of Fe₂O₃ due to heat treatment, so that the SiO₂ segregates to the grain boundary portion. For this reason, unevenness in film occurs and a resistance variation due to heating occurs.

From the above, as the composite metal oxide film formed on a glass base material of a spacer, a solid solution of a metal oxide having semiconductivity and a metal oxide having insulating properties is preferable. More preferably, the valence of the positive ion existing in the above-described metal oxide having semiconductivity is equal to the valence of the positive ion existing in the above-described metal oxide having insulating properties. Further more preferably, these ion's radiuses have such a close value as to be able to form a solid solution.

In this example, paying attention to the oxides, such as Fe₂O₃, which is a trivalent metal oxide, it was confirmed that these have an excellent effect, however, a metal oxide, e.g., ZnO, CoO, or the like, which forms a bivalent or tetravalent solid solution may be used.

Next, the result of study regarding the film thickness of the composite metal oxide films formed on a glass base material of a spacer is described. No. 32 to No. 42 of Table 1 show the properties in the case where the film thickness of the composite metal oxide film of 70% Fe₂O₃ and 30% Ga₂O₃ by mole ratio on oxide conversion was varied.

No. 32 to No. 38 are the examples in the case where the film thickness was set to 10 nm to 200 nm, and in either case, no problem was found in all the items of the surface resistance value, unevenness in film after heating, thermal runaway, emission degradation, beam deflection, and power consumption, which was excellent.

No. 41 and No. 42 are the cases where the film thickness is as thick as 300 nm and 500 nm, respectively, and in these cases, slight unevenness in film occurred after heating. This unevenness in film was unevenness in film caused by film peeling due to a stress between the film and the base material because the film thickness is thick unlike the case where SiO₂ is mixed, or unevenness in film caused by grain growth due to heating.

The film thickness of a composite metal oxide film formed is therefore preferably equal to or less than 200 mm. If the film thickness of a composite metal oxide film exceeds 200 nm, unevenness in film will occur after heating, which is not desirable. In this experiment, there was no problem in No. 39 and No. 40 whose film thickness is 5 nm and 7 nm, respectively, however, if the film thickness of a composite metal oxide film is less than 10 nm, suppression of the volatilization of a glass composition tends to be insufficient, so the minimum value of the film thickness is preferably 10 nm.

Now, it has been demonstrated that a composite metal oxide film composed of a combination of either one of Fe₂O₃, Cr₂O₃, Ni₂O₃, V₂O₃, Rh₂O₃, Mo₂O₃, and Ru₂O₃, with Ga₂O₃, and a composite metal oxide film of Fe₂O₃ and Al₂O₃ are less affected by heat applied during panel manufacture process. This combination is an example, and for example, a composite metal oxide of Cr₂O₃ and Al₂O₃ is also effective.

It should be further understood by those skilled in the art that although the foregoing description has been made on embodiments of the invention, the invention is not limited thereto and various changes and modifications may be made without departing from the spirit of the invention and the scope of the appended claims.

### ADVANTAGES OF THE INVENTION

The present invention may provide a spacer that is unlikely to degrade due to heating applied during manufacture process of an image display device.

1. An image display device comprising:
a cathode substrate including an electron source;
an anode substrate including a fluorescent substance that emits light upon receiving electrons emitted from the electron source; and
a spacer that is disposed between the cathode substrate and the anode substrate and supports the both substrates,
wherein the spacer comprises the one having a film composed of a composite metal oxide on a side face of a glass base material,
wherein the composite metal oxide is composed of a solid solution of a metal oxide having a semiconductor-like electrical conductivity and a metal oxide having an insulator-like electrical conductivity.

2. The image display device according to claim 1, wherein the metal oxide having a semiconductor-like electrical conductivity contains a trivalent positive ion of either one selected from iron, chromium, manganese, nickel, vanadium, rhodium, molybdenum, and ruthenium.

3. The image display device according to claim 1, wherein the metal oxide having an insulator-like electrical conductivity contains a trivalent positive ion of either one selected from aluminum and gallium.

4. The image display device according to claim 1, wherein an element forming the composite metal oxide comprises one kind selected from iron, chromium, manganese, nickel, vanadium, rhodium, molybdenum, and ruthenium, and one kind selected from aluminum and gallium.

5. The image display device according to claim 1, wherein an element forming the composite metal oxide comprises iron and gallium.

6. The image display device according to claim 5, wherein an element forming the composite metal oxide comprises iron and gallium and contains 20% to 80% Fe₂O₃ and 80% to 20% Ga₂O₃ by mol % on oxide conversion of Fe₂O₃ and Ga₂O₃.

7. The image display device according to claim 1, wherein a surface resistance of a film composed of the composite metal oxide is in the range from 1×10¹⁰ Ω/square to 1×10¹³ Ω/square.

8. The image display device according to claim 1, wherein an element forming the composite metal oxide comprises either of chromium and gallium, iron and aluminum, manganese and gallium, nickel and gallium, vanadium and gallium, rhodium and gallium, molybdenum and gallium, and ruthenium and gallium.

9. The image display device according to claim 1, wherein a film thicknesses of a film composed of the composite metal oxide is in the range from 10 nm to 200 nm.

10. The image display device according to claim 1, wherein the glass base material of the spacer is composed of a conductive glass.

11. A spacer used for an image display device disposed between a back panel and a front panel of an image display device, the spacer having a film formed of a composite metal oxide on a side surface of a glass base material, the composite metal oxide being composed of a solid solution of a metal oxide having a semiconductor-like electrical conductivity and a metal oxide having an insulator-like electrical conductivity.

12. The spacer used for an image display device according to claim 11, wherein the metal oxide having a semiconductor-like electrical conductivity contains a trivalent positive ion of either one selected from iron, chromium, manganese, nickel, vanadium, rhodium, molybdenum, and ruthenium.

13. The spacer used for an image display device according to claim 11, wherein the metal oxide having an insulator-like electrical conductivity contains a trivalent positive ion of either one selected from aluminum and gallium.

14. The spacer used for an image display device according to claim 11, wherein an element forming the composite metal oxide comprises iron and gallium.

15. The spacer used for an image display device according to claim 14, wherein the iron and gallium are contained as 20% to 80% Fe₂O₃ and 80% to 20% Ga₂O₃ by mol % on oxide conversion of Fe₂O₃ and Ga₂O₃.

16. The spacer used for an image display device according to claim 11, wherein a surface resistance of a film composed of the composite metal oxide is in the range from 1×10¹⁰ Ω/square to 1×10¹³ Ω/square.

17. The spacer used for an image display device according to claim 11, wherein a film thicknesses of a film composed of the composite metal oxide is in the range from 10 nm to 200 nm.

18. The spacer used for an image display device according to claim 11, wherein the glass base material is composed of a conductive glass.

19. The spacer used for an image display device according to claim 11, wherein an element forming the composite metal oxide comprises either of chromium and gallium, iron and aluminum, manganese and gallium, nickel and gallium, vanadium and gallium, rhodium and gallium, molybdenum and gallium, and ruthenium and gallium.
